(19) United States
(12) Patent Application Publication
(10) Pub. No.: US 2009/0089184 A1
(43) Pub. Date: Apr. 2, 2009

(54) Content portal for media distribution

(75) Inventor: Carlton R. Boush, Akron, OH (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Embarq Holdings Company, LLC

(21) Appl. No.: 11/904,792

(22) Filed: Sep. 28, 2007

(51) Int. Cl. G06Q 30/00; G06F 17/30; G06F 17/40

(52) U.S. Cl. 705/27

(57) ABSTRACT

A system and method for distribution of media content. A distribution agreement is established with content providers. The distribution agreement authorizes the content providers to communicate media content to a content portal with a commission paid to the content portal. An authorization to distribute the media content is granted to the content providers in response to establishing the distribution agreement. A menu of the available media content is sent to users. The menu lists all of the media content available and a current price updated in real-time based on information from the content providers. A request is received for the media content from the users. The requested media is distributed to the users. An invoice for the users is updated based on the current price of the media content as ordered. The revenue, minus the commission, associated with the invoice is received for payment to the content providers.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND

Availability of media content has grown nearly exponentially in recent years. Advances in communications, distribution, recording, viewing, and transmission technologies and standards have fostered this growth. Despite the current technological advancements, most forms of media content are bundled together in different packages for consumption by customers. For example, cable companies often bundle channels, on-demand programs, sports broadcasts, and media programming. This model is inefficient on a number of different levels.

Despite availability to a large amount of media content, most users typically regularly watch only twenty percent of available resources in a given time period. Correspondingly, customers pay for one hundred percent of content even though only twenty percent is regularly accessed resulting in various pricing inefficiencies to the customer. In addition, if the customer desires to access content not available through a purchased media package, the user may be required to upgrade to a larger package or add on a secondary package or programming.

In many cases, the price of media content is further increased by the agreements between the media content provider and the content distributor. In many cases, the programming that most increases the fees associated with bundles may be related to content the user does not regularly watch, thereby unnecessarily increasing customer costs.

Bundling media content is especially inefficient for Internet Protocol television (IPTV) technologies because of the bandwidth constraints on data connections to a customer's home. As a result, adaptation to customer preferences remains low and costs to content providers and customers remain high.

### SUMMARY

One embodiment includes a system and method for distribution of media content. A distribution agreement may be established with content providers. The distribution agreement may authorize the content providers to communicate the media content to a content portal with a commission paid to the content portal. An authorization to distribute the media content may be granted to the content providers in response to establishing the distribution agreement. A menu of the media content available may be communicated to users. The menu may list all of the media content available and a current price updated in real-time based on information from the content providers. A request may be received for the media content from the users. The requested media may be distributed to the users. An invoice for the users may be updated based on the current price of the media content as ordered. The revenue, minus the commission, associated with the invoice may be received for payment to the content providers.

Another embodiment includes a portal for distributing media content. The portal may include a content aggregator for receiving media content and information about delivery of the media content from multiple content providers. The multiple content providers may establish a distribution agreement with an operator of the portal before the media content may be received. The portal may include a pricing database in communication with the content aggregator configured to display a current price for the media content, wherein the current price is updated in real-time at the discretion of the multiple content providers. The portal may include a billing system configured to initiate billing of multiple users for the media content ordered based on the current price, and further configured to initiate payment to the multiple content providers for revenue generated from the current price, minus a commission. The portal may include a menu system configured to display a menu listing available media content available from the multiple content providers providing details about the media content including the current price.

Yet another embodiment includes a content portal. The content portal may include a processor for executing a set of instructions. The content portal may also include a memory for storing the set of instructions. The set of instructions may be configured to establish a distribution agreement with multiple content providers, wherein the distribution agreement authorizes the multiple content providers to communicate media content to a content portal with a commission of revenue paid to the content portal; grant an authorization to distribute the media content to the multiple content providers in response to establishing the distribution agreement; communicate a menu of the media content available to one or more users, wherein the menu lists the media content available and a current price that is updated in real-time at the sole discretion of the multiple content providers; receive a request for the media content from the one or more users; distribute the media content requested to the one or more users; and update an invoice for each of the one or more users based on the current price of the media content at the time the request was made.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a telephony network in accordance with an illustrative embodiment;

FIG. 2 is a pictorial representation of a home network in accordance with an illustrative embodiment;

FIG. 3 is a block diagram of a content portal in accordance with an illustrative embodiment;

FIG. 4 is an illustration of a content menu in accordance with an illustrative embodiment;

FIG. 5 is a pictorial representation of interactions between a content provider and a content portal;

FIG. 6 is a flowchart of a process for distributing media content in accordance with an illustrative embodiment; and

FIG. 7 is a flowchart of a process for receiving media content in accordance with an illustrative embodiment.

### DETAILED DESCRIPTION OF THE DRAWINGS

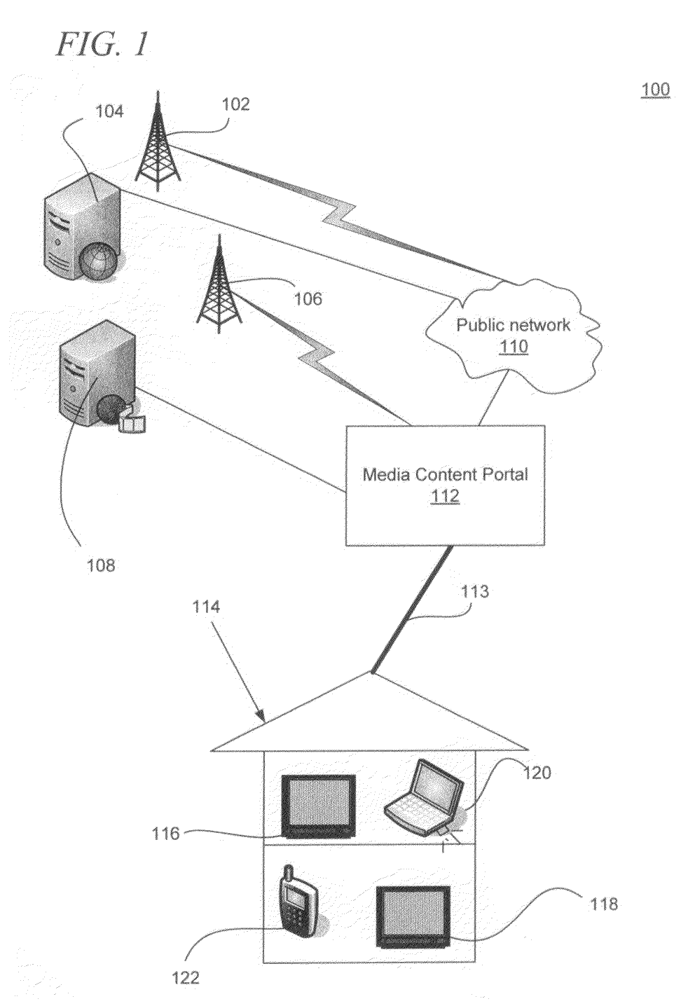

FIG. 1 is a pictorial representation of a telephony network 100 in accordance with an illustrative embodiment. The telephony network 100 of FIG. 1 may be embodied by numerous configurations of communications service providers, devices, and other network elements. The telephony network 100 is a communications network and infrastructure for delivering communications services to multiple users. The telephony network 100 may be used to provide data and communications services, as well as media content. Media content, as herein defined, includes television channels and programming, movies, music, pictures, on-demand requests, pay-per-view events, live and pre-recorded streaming media, gaming, interactive programming, and other forms of informational and entertainment content.

The telephony network 100 may include any number of elements, including content providers 102, 104, 106, and 108, a public network 110, a media content portal 112, a data connection 113, a home 114, televisions 116, 118, a computer 120, and a wireless device 122. The content providers 102, 104, 106, and 108 may transmit media content directly to the media content portal 112 or they may transmit the content through the public network 110.

The public network 110 may be any network suitable for transmission of data, information, or media content. In one example, the public network 110 is the Internet or worldwide web. Alternatively, the public network 110 may be one or more networks which may include private or mixed-use networks. The content providers 102, 104, 106, and 108 may send and receive information, and specifically media content, through wireless or wired connections. In one embodiment, the content provider 106 wirelessly broadcasts a television program to the media content portal 112. In another example, the content provider 108 has a dedicated fiber optic connection to the media content portal 112 for further distribution to any number of users with access to the media content portal 112.

The content providers 102, 104, 106, and 108 are media content service providers and represent the hardware, software, and other infrastructure used by content originators in order to provide media content to the media content portal 112. The content providers 102, 104, 106, and 108 may be large-scale television networks or they may be content services ran and supported by individual providers. For example, the content provider 102 may be a national network that broadcasts television programming, updated news broadcasts, and is otherwise well established. Alternatively, the content provider 104 may be a family-run religious station operated using a digital camcorder and a server to broadcast content through the public network 110 to the media content portal 112.

In one embodiment, the content providers 102, 104, 106 and 108 may be required to establish a distribution contract with the media content portal 112 before they are allowed to send media content to the media content portal 112. For example, the content providers 102, 104, 106 and 108 may have used an on-line distribution contract made available by the media content portal 112 to sign up and agree to payment terms and broadcast standards before the media content may be sent to the media content portal 112. The content providers 102, 104, 106 and 108 may store and market the media content based on individualized business plans and market share. The broadcast types of the media content available through the content providers 102, 104, 106 and 108 may vary from high-definition to standard transmission quality for a television or computer. Various decency, transmission, and broadcast standards and protocols may be developed and implemented by the operator of the media content portal.

The media content portal 112 is a distribution system configured to receive media content from the content providers 102, 104, 106, and 108 for distribution to consumers such as the home 114. The media content portal 112 may be one or more networked devices, software, or hardware and software combination for receiving media content, sending a menu of the available content to one or more users including availability and price information, distributing media content, and billing users based on requested media content. The media content portal 112 also referred to as the content portal, media portal, or portal may include or communicate with any number of servers, routers, encoders, decoders, tuners, and other computing and communications equipment necessary to send and receive media content and communications. In one embodiment, the media content portal 112 may be provided by a local telephone company that also offers IPTV, Voice over Internet Protocol (VoIP), data connections, wireless telephone and data service, and plain old telephone service (POTS) to a large number of customers. For example, the home network 200 may also display caller identification information and allow calling from any of the interconnected devices that are call capable.

The home 114 is an illustration of one or more users or customers. The home 114 may also be a business, residence, organization, company, or other building, group, or communications user. The televisions 116 and 118, the computer 120, and the wireless device 122 may be used to display the media content received from the media content portal 112. The media content portal 112 may be connected to the home 114 through the data connection 113. The data connection 113 is a network connection for sending and receiving media content, communications, information, and any other type of electronic data. In one embodiment, the data connection 113 is provided by the operator of the media content portal 112. The data connection 113 may be a wireless or wired connection. The data connection 113 may also be used to send and receive voice communications using a plain old telephone service (POTS) connection or VoIP.

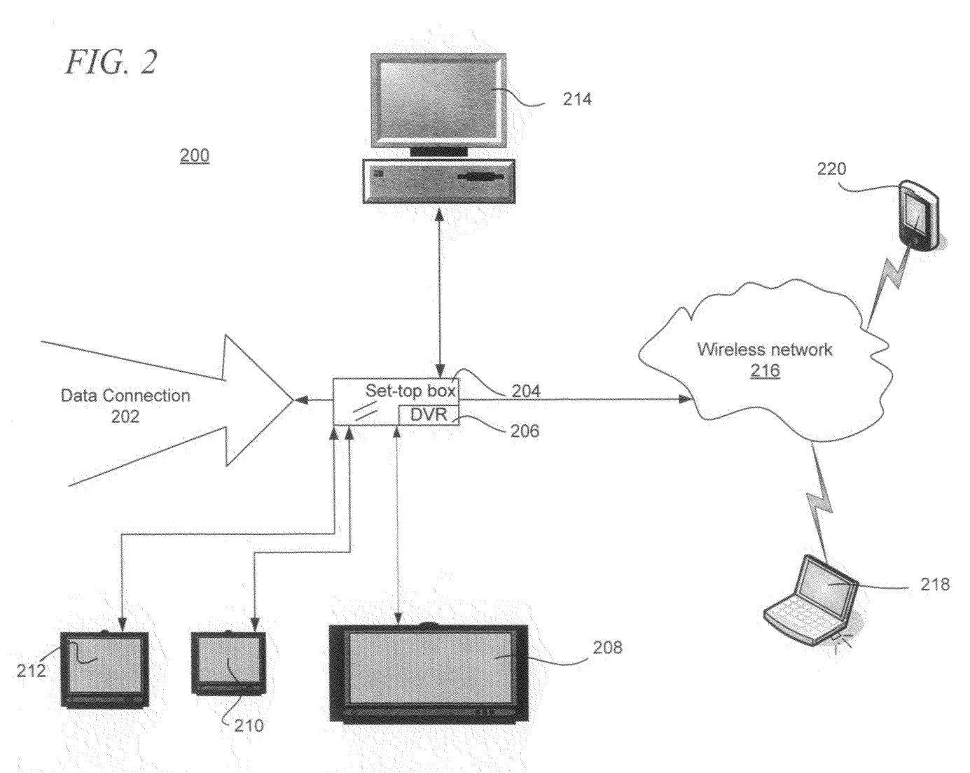

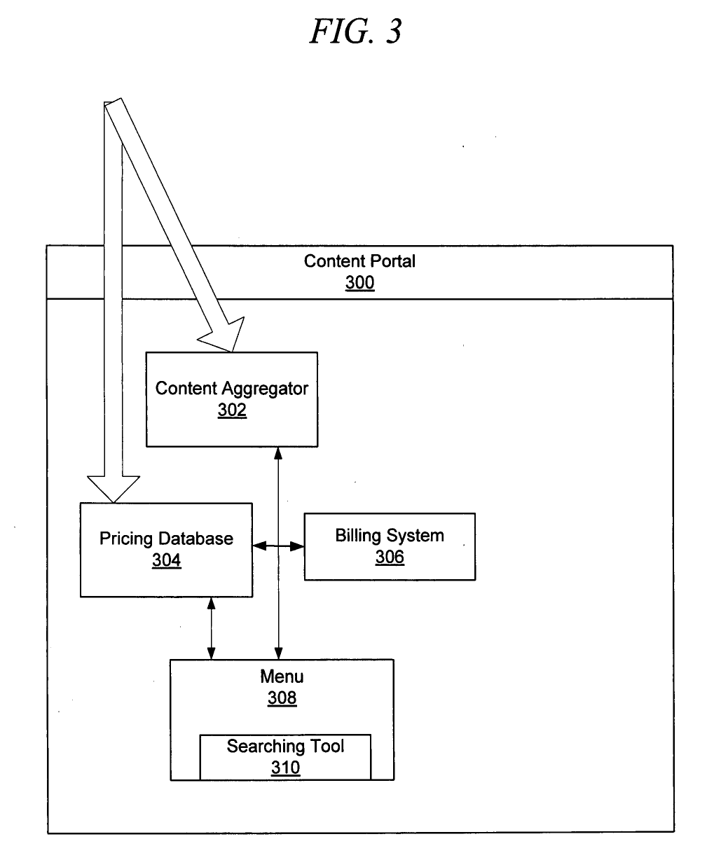

In one example, the media content portal 112 may send and receive data that includes media content through a fiber optic connection. In another embodiment, the media content portal 112 may be connected to the home 114 through a WiMAX Ethernet, or DSL connection. The media content portal 112 is further described in FIG. 3. The home 114 and a corresponding home network is further described in FIG. 2.

FIG. 2 is a pictorial representation of a home network in accordance with an illustrative embodiment. FIG. 2 illustrates one embodiment of a home network 200. The home network 200 may include a number of elements, including a data connection 202, a set-top box 204, a DVR 206, televisions 208, 210 and 212, a personal computer 214, a wireless network 216, a laptop 218, and a wireless device 220. The various elements may be a particular implementation of the data connection 113 and home 114 of FIG. 1.

As shown in FIG. 2, the data connection 202 may provide media content, packets, information, and data to the set-top box 204 for distribution to the televisions 208, 210 and 212, personal computer 214, and the wireless network 216. In one embodiment, the data connection 202 may be a DSL connection. The content stream through the data connection 202 may be a unicast broadcast intended only for the set-top box 204 and the corresponding user or it may be a multicast broadcast being simultaneously received and processed by a number of set-top boxes. The content stream may be a high-definition or regular digital broadcast sent, routed, and received from any number of networks, servers, routers, Digital Subscriber Line Access Multiplexer (DSLAMS), advanced intelligent devices, or other networks or components. The content stream available through the data connection 202 may be established with the content portal that may be integrated with IPTV network components by sending an add stream or stream origination request. The add stream request may be a message or command sent from the set-top box 204 that requests a content stream for a specified channel, video-on-demand, program, or other media content. The add stream request may be authenticated based on information, passwords, or other identifiers sent by the set-top box 204. The set-top box 204 and content portal may use Internet Group Management Protocols (IGMP), control signals, configurations, formats, and standards for receiving broadcasts.

In one embodiment, the DVR 206 is integrated with the set-top box 204. The set-top box 204 allows a user to receive digital television service through the data connection 202 using Internet Protocol over a network infrastructure. The set-top box 204 may be a device that functions as a translator or intermediary between the television 208 and the other home network 200 devices and the data connection 202. The set-top box 204 may convert, format, or translate the signal received through the data connection 202 to be displayed on downstream devices.

The DVR 206 is a device that records media content in a digital format to a disk drive or other memory medium. In the home network 200, the set-top box 204 may be a computer or computing device providing communications on an IP network that decodes the media content for display by the downstream devices. The set-top box 204 and DVR 206 may include a processor, memory, and other common computing elements. The set-top box 204 allows a user to specify and change the content stream streamed through the data connection 202 to the home network 200 devices.

In particular, the set-top box 204 and DVR 206 may store and/or execute programs, operating systems, or instructions for controlling the media content, playback user interaction, and other interactive features available to a user through the television 108. The DVR 206 may enable a user to capture video, media, or other content for playback from a disk or a memory of the DVR 206. The DVR 206 may provide the user with the ability to record programs, features, or other media for playback at the user's convenience. In most cases, the DVR 206 may store the digital stream from the data connection 202 directly to disk or playback at a specified time.

The user may set preferences in the set-top box 204 or DVR 206 for automatically or manually selecting and recording programs. For example, the user may specify that the DVR 206 is to record every program of a specified type that is available through the channels or contents stream of the data connection 202. In another example, the user may set the DVR 206 to record a one-time event or a single program. For example, the user may use an infrared remote or cellular telephone to change channels and record programs. The user may interact with the set-top box 204, DVR 206, and other home network 200 devices using one or more remote control devices. The set-top box 204 may include any number of buttons, indicators, displays, touch screens, or other interactive elements for receiving user input and providing information to the user. The DVR 206 may also download and store media content from the content portal as a background function or when bandwidth is not being optimally utilized.

The set-top box 204 and DVR 206 may communicate with or be connected to the home network 200 devices through a hard-wired or wireless connection. In one embodiment, the set-top box 204 and television 208 may communicate through a high-definition multi-media interface (HDMI). However, the connection may be any digital audio/video interface suitable for transmitting and/or compressing media streams. The set-top box 204 and television 108 may use any number of digital connection or analog standards and converters to send and receive information.

In another embodiment, the set-top box 204 and home network 200 devices may communicate through a wireless connection, such as Bluetooth® or WIFi connection, such as IEEE 802.11(n). The connection between the set-top box 204 and the other devices of the home network 200 may be used to carry video, audio, and other device controlling signals.

The set-top box 204 may be configured to send add stream requests for each device of the home network 200. The set-top box 204 may function as a routing and control device for all communications into the home network 200. In one embodiment, the set-top box may also be connected to a VoIP telephone or configure data sent over the data connection 202 to enable telephone conversations. The set-top box 204 may also be connected to any number of peripheral devices including, but not limited to, a wireless remote control, keyboard, webcam, or other input/output device. The set-top box 204 may function as a portal allowing Internet browsing and shopping. In one embodiment, the menu may be integrated with an Internet browser in order to allow media content, marketing, sales, and information to be more easily exchanged when ordering media content, during display of the media content, or after display. For example, a user may be able to review automobile types displayed in a movie, view actor biographies, and order an upcoming sequel to the movie from the menu/web browser.

In one example, the set-top box 204 may request a high-definition MPEG 4 content stream from a high definition content provider. The bandwidth required through the data connection may vary for the different video compression schemes based on the applicable standards and formats, content service provider, and user and provider devices. In one example, applicable bandwidth requirements for each of the televisions 208, 210, and 212 may vary based on compatibility with traditional or future video compression formats. The set-top box may simultaneously process a change channel request that ends one stream and requests another stream for television 210, while television 212 has requested that a separate channel be recorded by the DVR 206.

The set-top box 204 may also control how and when media content is downloaded. For example, media content that is requested may be downloaded when utilization of the home network 200 is low or under specified thresholds. For example, movies requested during the day may be downloaded at night when the data connection has increased bandwidth available. The user may establish preferences and guidelines for downloading or uploading media content that does not have a strict viewing timetable. In another embodiment, the set-top box 204 may allow a user to function as a content provider to uploaded media content that has been recorded, edited, or otherwise generated using a device in communication with the home network 200.

The personal computer 214 and wireless device 220 and the laptop 218 may similarly request media content through the set-top box 204. In one embodiment, the set-top box displays a menu that is configured for all of the devices of the home network 200. The set-top box 204 may be integrated or mounted in a structured wiring cabinet with access through an infrared remote control or radio transceiver remote. In another embodiment, the set-top box 204 may be configured and operated through a CableCARD or a CableCARD-equipped device. In order to receive media content, communications, data, and other information from the set-top box 204, the personal computer 214, televisions 208, 210, and 212, the wireless device 220, and the laptop 218 may be required to register a media access control address (MAC), Ethernet Hardware Address (EHA), hardware address, or other identifier with the set-top box. Alternatively, the identifier may be registered with the content portal for distribution purposes. For example, the user may register an identifier of all devices that may receive media content through the content portal and set-top box.

Although not further illustrated, the wireless network 216 may include a wireless router or server for sending and receiving data signals to the wireless device 220, the laptop, and other household or user devices. The home network 220 may further include any number of communication devices, such as standard telephones and VoIP telephones. The voice communications may be similarly routed through the set-top box 204 through a wireless or wired connection. In one embodiment, the wireless device 220 may use cellular signals or a wireless signal, such as WiFi, from the wireless network 216 to send and receive voice communications.

The set-top box 204 may be configured using any of the devices of the home network 200 or using remote controls for each of the devices. In one embodiment, programming for the set-top box 204 may be configured through the personal computer 214 or laptop 218 which may communicate directly with the set-top box 204. For example, the personal computer 214 or television 210 may be used to request media content to be displayed to the television 210 in real-time. Content requests and recording time may be set by any number of users with access to the set-top box 204.

A running total of costs incurred through the home network 200 may be updated by the media portal for real-time access from the home network 200. As a result, the consumer may be able to determine the budget for media content based on usage. In one embodiment, the set-top box 204 may require a password or authentication in order to view content. The set-top box 204 may similarly store preferences regarding rating, price, time of day, maximum number of hours per day, and other content criteria. The set-top box 204 may request an identifier in order to access media content. The identifier may be linked with a profile that specifies permissions and other viewing criteria. For example, parents may be required to enter a pass code in order for the set-top box 204 to order media content for a program that costs more than two dollars, that is not rated G or PG, or occurs after 5:00 p.m. to ensure that media content consumption is in accordance with individual or family rules, policies, or preferences. In another embodiment, the wireless device 220 may be continuously updated with media content being streamed through the set-top box 204 to the different devices of the home network 200. Similarly, the wireless device 220 may be used to order, terminate, or record specified media content using permissions, passwords, encryption keys, or other information.

In one embodiment, the set-top box 204 may require a DRM key in order to view, record, or otherwise access media content. The DRM key may be transmitted to the set-top box 204 when the media content is ordered, requested, or begins streaming. The DRM key may include parameters that control the usage, viewing, recording, and transfer of the media content. Once the DRM key expires, the user may be required to request a new DRM key or renew the previous key in order to view the media content. In one embodiment, the user may purchase media content and receive a DRM key linked or stored in the media content that allows the user to view the media content as frequently as desired, transfer the media content, and otherwise control the media content.

FIG. 3 is a block diagram of a content portal 300 in accordance with an illustrative embodiment. The content portal 300 is a particular implementation of the media content portal 112 of FIG. 1. The content portal 300 may be a single device or software application, or multiple devices networked to perform the features and services herein described. In one embodiment, the content portal 300 may include a content aggregator 302, a pricing database 304, a billing system 306, a menu 308, and a searching tool 310.

The content portal 300 may be a combination of hardware and software elements. The content portal 300 may incorporate various structures, formats, and hardware/software combinations. Although not shown, the content portal 300 and the set-top box 204 of FIG. 2 may include common computing elements such as a processor, memory, communications hardware, and other similar components. The processor may be a computer processor or other processing device or element used by the content portal to process instructions, convert and translate data, render video, and otherwise perform data manipulation and processing as required. The memory may include a hard drive and flash memory for storing or buffering television programs, data, applications, and user preferences. However, the memory may be any static or dynamic memory type or configuration suitable for storing and accessing electronic information and data.

The content aggregator 302 may receive media content from the content providers; in particular, the content aggregator 302 may configure the incoming data streams or media content for further transmission to one or more users. For example, media content that is to be displayed in high-definition may need to be transmitted differently than a standard television program. The content aggregator 302 may buffer incoming signals so that the media content is instantly available to a user once selected.

The content aggregator 302 may further stream the media content through a data connection to one or more devices as requested. For example, if a user purchases an on-demand program, the content aggregator 302 may begin streaming the content immediately or at the appointed time. In one embodiment, the content aggregator 302 may include a digital rights management (DRM) key or authentication server or other authentication module suitable to ensure that the user has in fact ordered the specified media content or that the user is authorized to order the media content.

The pricing database 304 may be used by the content portal 300 to track the current price for a program, series of programs, special event, on-demand feature, live or pre-recorded streaming media, or gaming program or other interactive or recordable media content. The pricing database 304 functions in conjunction with the billing system 306 in order to constantly update the price for media content. As a result, a user may be able to preselect media content at an earlier time to receive a discount on the price. Alternatively, the user may select the program at the last moment to get the standard price. For example, a pay-per-view professional wrestling match may only cost $10 when purchased two months before the event; if the user selects to purchase the event only one month in advance, the price may be $30; and if the user selects to purchase the event right at the time it is streamed live; the price may be $75.

The content providers may update the price stored in the pricing database 304 at their sole discretion. As a result, the content providers may use whatever pricing they determine reasonable or acceptable to consumers. The free market pricing may allow content providers to more effectively reach customers and maximize profits by dynamically adjusting prices up or down based on the goals, models, and constraints without interference by the operator of the content portal 300. In some cases, content providers may make programming free because of the amount of commercials included in the broadcast. In other cases for special events, the pricing may be extremely high, such as $20 for a program, based on the perceived demand or consumer appetite for the programming.

The billing system 306 records charges as selected by the user for specified programs. Because the user is charged only for selected programs, the user may be able to reduce the overall bill as compared to a bundled entertainment or media package. The billing system 306 may update charges for selected media content as ordered by the user. In particular, the billing system 306 may aggregate inventory or invoice watched programs to generate a daily, weekly, or monthly billing invoice for the user. In one embodiment, the billing system 306 may display the current monthly bill to a user each time a program or channel is purchased in order to allow the user to moderate costs and know where the current user bill currently stands. Alternatively, the user may access the billing system 306 through an Internet portal in order to review the costs accrued. The billing system 306 may also use email, chat, or text messages to update the user and may be integrated with the user's other telephony services or billing access.

The pricing database 304 may extract the price from the stream that is sent by the content provider, or alternatively, the pricing database 304 may receive a price-specific message or streaming data from the content provider. The pricing database 304 may be configured to communicate with the menu 308. The menu 308 displays the available content to one or more users. In particular, the menu may show all of the available content, including viewing information such as cost, starting and ending time, duration, rating, content summary, or other information that may be used by the user to decide whether to watch or record the program.

The menu 308 may be a software program configured to efficiently display the media content to one or more users. The menu 308 may be personalized or customized for individual users or for specified groups or target audiences. As a result, the menu 308 may display default information that is different for a 13-year old girl and a 65-year old man. The searching tool 310 may be used to search through the media content available on the media 308. For example, the searching tool 310 may receive user feedback to sort or retrieve specified media content based on key words, start times, price, or other search criteria. In one embodiment, a user profile may be associated with the menu 308. By entering an identifier or password, a set-top box may request that the content portal 300 configure the menu based on permissions, preferences, and other criteria. For example, the menu, by default, may be configured to not display any media content that has a rating other than G or PG or relevant equivalents.

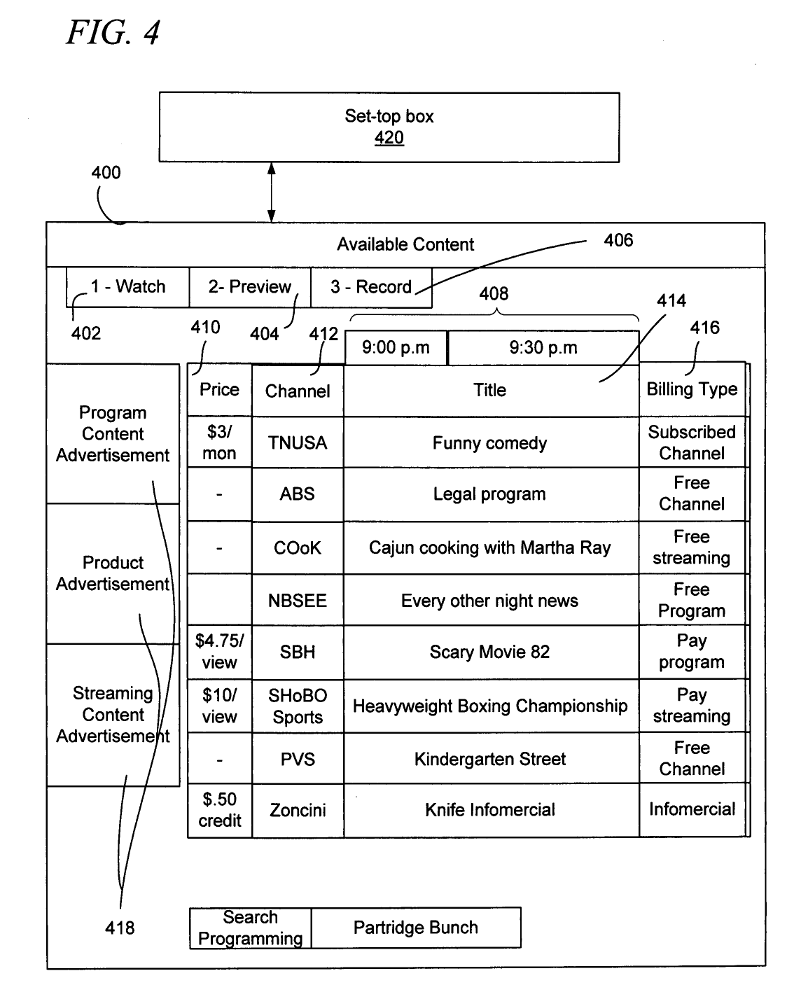

FIG. 4 is an illustration of a content menu 400 in accordance with an illustrative embodiment. The menu 400 of FIG. 4 may include various elements, including a watch selection 402, a preview selection 404, a record selection 406, program times 408, a price 410, a channel 412, a title 414, a billing type 416, and advertisements 418. The menu 400 may be received and interactively displayed as a user interface accessible through a set-top box 420. The set-top box 420 may be of particular implementation of the set-top box 204 of FIG. 2.

The menu 400 may be transmitted by the media content portal or may be further configured by the set-top box 420 to be displayed by an electronic device such as a television, computer, or wireless device. The menu 400 may encourage the user to provide feedback or input through peripherals or input devices in communication with the set-top box 420. In particular, the user may use a remote control, mouse, touch screen, infrared or laser pointer, scroll wheel, keyboard, or other similar device to receive instructions for the selection of media content and the configuration of the menu 400.

The watch selection 402 allows a user to select media content to view. The preview selection 404 may allow a user to preview the media content. For example, the content provider may allow a preview or live feed of the media content to be temporarily displayed to the user in order to encourage the user to purchase or view the selected media content. The record selection 406 may command the set-top box 420 to record the specified media content. The record selection 406 may be used for programs that are currently being displayed or that may be displayed in the future. In addition, the record selection 406 may be used to record a series of media content; for example, the user may select to automatically record a favorite television program.

The program times 408 may be used to display available media content based on the time of day. The menu 400 may display content that is currently ongoing or that may occur in the future. The advertisement 418 may be displayed to the user based on the distributor controlling the media content portal by using one or more user profiles or based on user preferences. For example, if the user has provided a profile or feedback indicating a specific interest in a type of programming such as mixed martial arts competitions, the advertisements 418 may display specific products, programs, or streaming content that may be purchased by the user.

The menu 400 may also display the price 410 for the displayed media content. In some cases, the price may indicate that the programming is free to the user. In other embodiments, the price may be displayed per channel, program, or media event. In one embodiment, the user may actually receive credits or money for watching or interacting with a specified program, infomercial, or survey. As previously described, the price 410 may be set and adjusted at the sole discretion of the content provider in order to maximize viewership, profits, or further specified business, organizational, or personal interests. In one embodiment, the content provider may prorate the price based on the portion of the program yet to be watched.

The channel 412 may specify the content provider or content originator. The title 414 may indicate the title of the media content or a description that allows a user to distinguish the type of content that may be displayed. As a viewer views the menu 400, additional information including further details, summaries, and information may be displayed or made available to the user. The billing type 416 may further indicate how the channel 412 is billed. The billing type 416 may include categories or designations such as subscribed channel, free channel, free streaming, free program, pay programming, pay streaming, or infomercial in addition to other specified billing types. For example, if the user has already purchased a specified channel, the billing type 416 may indicate that it is a subscribed channel. The billing type 416 may further indicate how the media content is displayed or streamed. For example, some media content is prerecorded or available only at specified time periods. In other examples, the media content is available on demand or as requested.

In one embodiment, the different media types may be displayed in different colors. For example, selections shown in red may represent programs that have already been purchased or are free; content in blue may represent live or streaming content; and content in green may be pre-recorded and available at anytime. The menu may take up negligible bandwidth as streamed to the set-top box and provide a central point through which many users may access media content. Individual users may set up preferred content providers, media content, or types of media for more effectively viewing the menu 400. In one example, the user may rank channels 412 or content providers in order to set default preferences for the content that is initially displayed on the menu 400. Alternatively, the user may set up preferences in folders, such as movies, sports, education, and music. As a result, the user may be able to access a movie broadcast by a major network provider or a small Bluegrass instructional video recorded and streamed from the set-top box of another user.

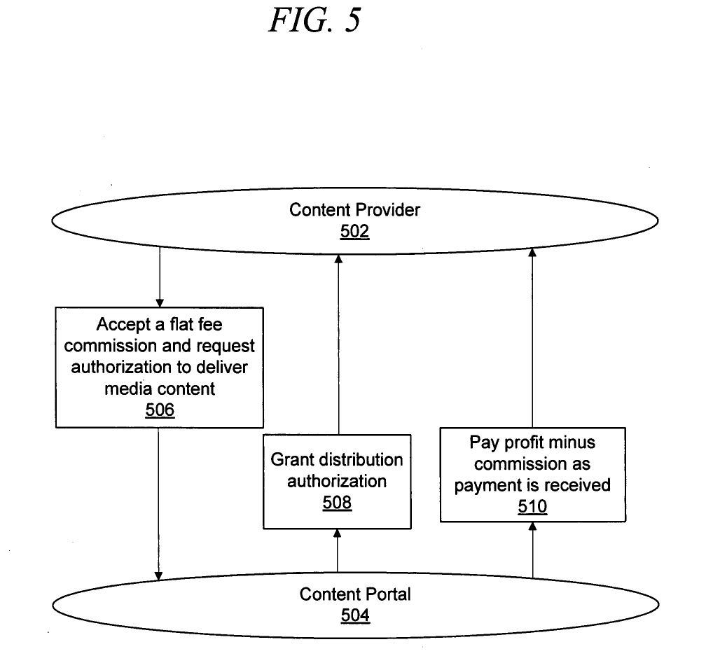

FIG. 5 is a pictorial representation of interactions between a content provider 502 and a content portal 504. In particular, the content provider 502 and the service provider offering the content portal may establish a distribution agreement. The distribution agreement is a contract or agreement that establishes cost and service terms and requirements for the receipt and distribution of media content received by the content portal 504 from one or more content providers. The content provider 502 and content portal 504 may establish various policies and agreements in order for the content portal 504 to distribute media content provided or originating from the content provider 502.

In one embodiment, the content provider 502 may accept a flat fee commission and request authorization to deliver media content 502 to the content portal 504. In one preferred embodiment, the content portal 504 or distributor operating the content portal 504 may provide an on-line form or other contract that may be retrieved by individual content providers. For example, the contract to provide media content may be filled out on-line and submitted electronically through the content portal 504. The flat fee may be a fee charged by the content portal 504 to the content provider 502 to distribute media content.

In one embodiment, the agreement may be tiered with different flat fee commissions specified based on the number of viewers that view the content as transmitted or within a specified time period. For example, the flat fee per commission may be 20% for less than 10,000 viewers; 18% for between 10,001 and 50,000 viewers; 15% for between 50,001 and 250,000 viewers; and 12% for viewership greater than 250,001 viewers within a week. In another embodiment, the content provider 502 and provider of the content portal 504 may negotiate customized fees. This may be especially relevant for large-scale broadcasts or extremely popular media content.

Next, the content portal 504 grants a distribution authorization, step 508. The content portal 504 may grant the distribution authorization by providing a key, password, or IP address to which the media content is transmitted by the content provider 502. For example, the content provider 502 may stream a concert performance event to the content portal 504 that is directed to a specified IP address or port linked with the content provider 502. Next, the content portal 504 pays profit minus commission as payment received, at step 510. The commission may be the flat fee established in step 502. The profit is paid to the content provider 502 by the content portal 504 as each user is billed. The billing period may per week month or year, as specified by the content portal 504.

The flat fee commission, as specified in FIG. 5, may allow large and small content providers to have equal opportunities to distribution time and provide a level playing field for providing media content. In particular, some content providers may be more motivated to use the content portal 504 because of the single flat fee commission that is established ahead of time. As a result, the content provider 502 does not have to worry about hidden fees or other costs associated with distribution by the content portal 504.

The content provider 502 may control the media content that is distributed to one or more users. The content provider 502 may determine the content and format for the media content. For example, the content provider may determine whether or not the media content includes commercials. In one embodiment, the content provider 502 may provide the media content with and without commercials with a price that is increased for the identical media content without commercials. The content portal 504 provides a better open marketplace for distributing and receiving media content. Similarly, the content portal 504 does not regulate the price or cost to the users. As a result, the content provider 502 may dynamically adjust the price in order to maximize profits or based on the broadcast goals. For example, halfway into a live broadcast of a movie, the content provider may reduce the cost to one fourth of the cost that was charged at the time the broadcast began.

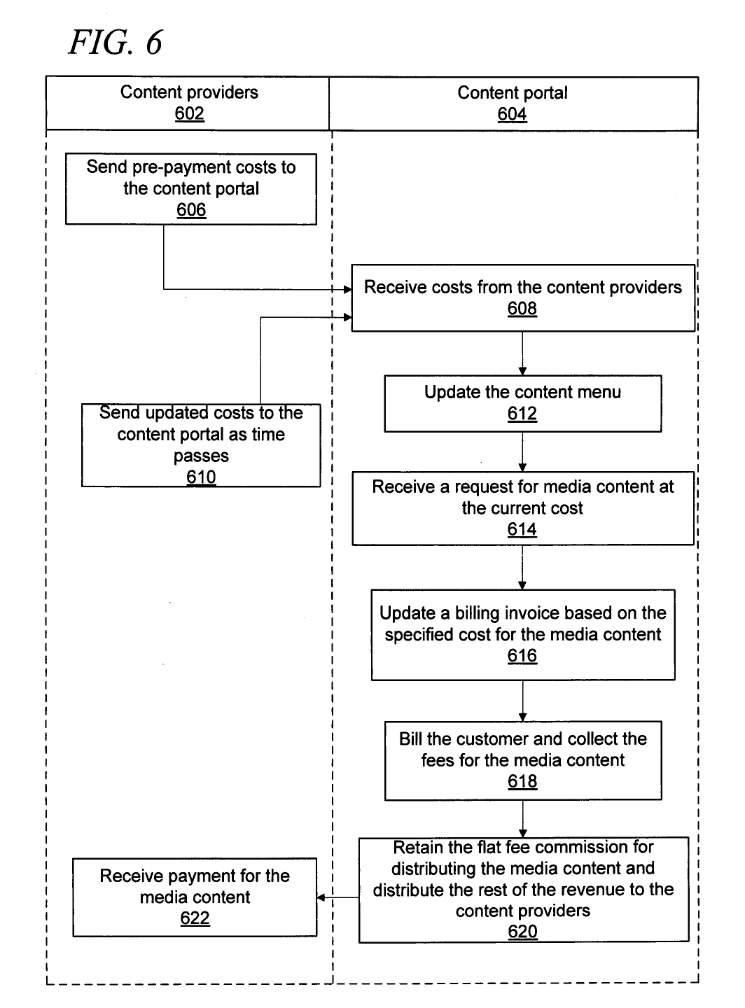

FIG. 6 is a flowchart of a process for distributing media content in accordance with an illustrative embodiment. FIG. 6 further describes the billing and distribution as herein described for the content provider 602 and a content portal 604.

The process may begin with the content providers 602 sending prepayment costs to the media portal (step 606). The prepayment costs explain the costs that will be charged to each user based on the timeframe in which they order the media content. For example, in most cases, the prepayment costs will increase as the specified time for delivery of the media content approaches.

The content portal 604 receives costs from the content providers (step 608). As time passes, the content providers 602 continue to send updated costs to the media portal 604 (step 610). Once the content portal 604 receives costs from the content providers, the content portal 604 updates the content menu (step 612). The menu lists the available media content that may be viewed or recorded for viewing at anytime.

The content portal 604 receives a request for media content at a current cost (step 614). The cost is specified by the content providers 602 in a step such as step 606 or 610. The request may be received from a set-top box or DVR accessible by the user. The user may provide user input using a remote control, keyboard, or other accessory or peripheral device.

Next, the content portal 604 updates a billing invoice based on the specified cost for the media content (step 616). The billing invoice may be maintained by a billing system or database in communication with the content portal 604. Next, the content portal 604 bills the customer and collects the fees for the media content (step 618). The customer may be billed at the time the media content is viewed, or alternatively, a record may be kept for billing the customer at a designated time; for example, the customer may be billed once a month for all media content used during the previous month or other specified billing period.

In another embodiment, the viewer may allot a specified amount or balance to a service account for purchasing media content. As the viewer purchases or requests media content, the balance is automatically reduced. As a result, the viewer may establish acceptable costs for the month and evaluate the available balance based on ordered media content as the month goes by. Based on the perceived value and effectiveness of the content, the user may be motivated to increase the balance through the set-top box or through an account available through the Internet. As a result, the user may effectively manage billing for each month.

The content portal 604 retains the flat fee commission for distributing the media content and distributes the rest of the revenue to the content providers (step 620). The revenue or profit that is sent to the content providers 602 may be expanded because only a small portion of the distribution is charged by the content portal 604 to the content providers 602. Next, the content providers 602 receive payment for the media content (step 622).

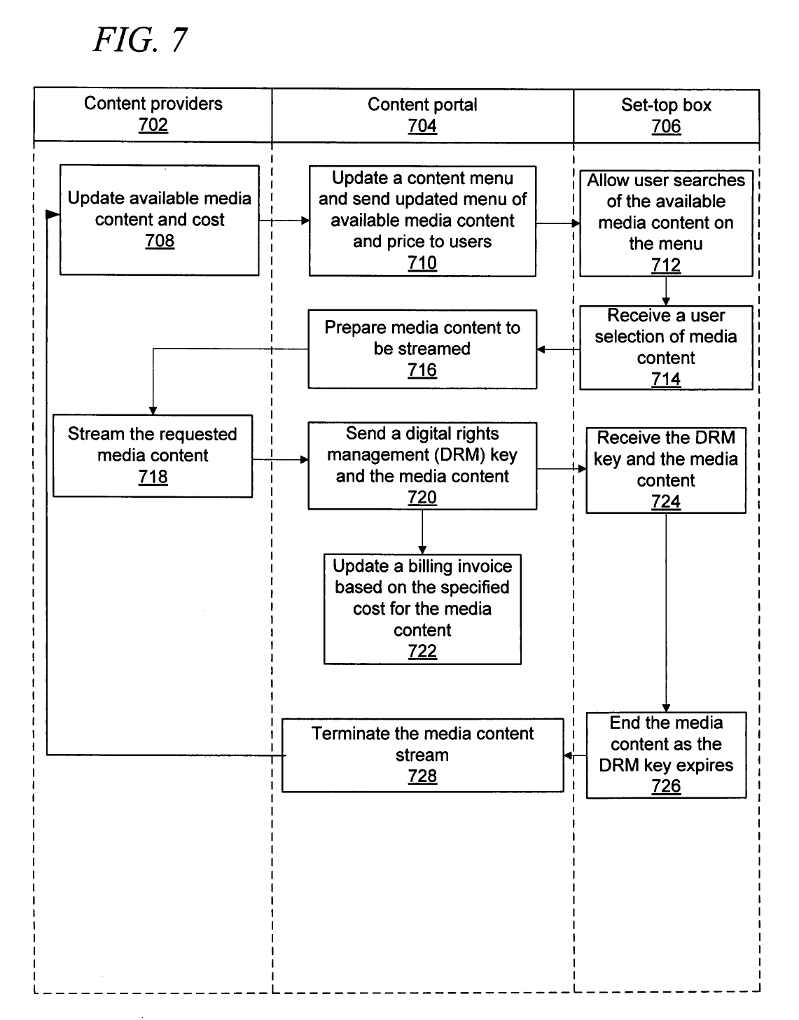

FIG. 7 is a flowchart of a process for receiving media content in accordance with an illustrative embodiment. The process of FIG. 7 may be implemented by content providers 702, a content portal 704, and a set-top box 706. There may be a requirement that negotiated distribution contracts are established between the content providers 702 and the content portal 704 before the process of FIG. 7 may be implemented. The contract may ensure that payment terms, quality assurance standards and protocols, and other important terms are negotiated before the content portal 704 makes the media content available to one or more users.

The process may begin by updating available media content and costs (step 708). The updating of step 708 may be performed by using messages, streaming data, or other communications protocols. The available programming provided by the content providers 702 and associated cost may be updated separately or together.

Next, the content portal updates a content menu and sends the updated menu of available media content and price (step 710). During step 710, the content portal may aggregate available media content and prices from any number of content providers 702. For example, hundreds of content providers 702 may update available media content and the associated price based on their individual schedules and judgment.

Next, the set-top box 706 allows user searches of the available media content on the menu (step 712). The user may utilize any number of search criteria or user feedback to search through the media content. For example, the user may search using a keyword, start time, or channel name. The user may also employ the set-top box 706 to filter media content based on criteria including, but not limited to, cost, start time, category, and channel.

The set-top box 706 then receives a user selection of media content (step 714). The user selection may be to display or record the media content immediately or at some time in the future. Additionally, a user may provide a user selection to subscribe to a channel or full-time media content from a source for a specified time period. For example, the user may order the Outdoors in the Caribbean network for the upcoming month at a specified price. In another example, the user may select to order a series of events, such as a concert series, television programming from the beginning of the season to the end, or a series of nature specials on potential effects of global warming on animal behavior.

The content portal 704 prepares the media content to be streamed (step 716). The media content may need to be reconfigured, formatted or otherwise configured for transmission to or display by the set-top box 706. The content providers 702 then stream the requested media content (step 718). The media content of step 718 may be live content, pre-programmed content, or previously-recorded content available on demand. Additionally, each different type of media content may vary in price from free to whatever price is charged by the content providers 702. The content portal sends a digital rights management DRM key and the media content (step 720). The DRM key may be used to ensure that the media content is authorized, viewed, and/or recorded under circumstances acceptable to the content providers 702. The content portal 722 updates a billing invoice based on the specified cost for the media content (step 722).

The billing invoice may be part of a billing system or billing database integrated with the content portal 704. The billing invoice may be recorded for a specified time period, such as a day, week or month. The billing invoice may be constantly updated based on programming requests from the user. As a result, at any time the user may review the current billing invoice in order to effectively manage the amount spent on media content each time period. In one example, the user may establish indicators or warnings for the user as the billing invoice reaches specified values or thresholds.

Next, the set-top box 706 receives the DRM key and the media content (step 724). The set-top box 706 may display configure, display, or record the media content as it is received in step 724. The set-top box 706 ends the media content as the DRM key expires (step 726). Simultaneously, the content portal 704 terminates the media content stream (step 728). The stream may also be terminated from the content providers 702 to the content portal 704. The DRM key may expire in step 726 based on previously-negotiated terms. For example, the DRM key may expire once the user has watched or accessed the entirety of the media content. In another example, the DRM key may expire after four days. In yet another example, the DRM key may expire after the media content has been viewed twice as recorded by a DVR.

Embodiments of the present invention allow a user to request and receive media content in a personalized and customized manner. As a result, content providers, the portal operator, and individual users are able to manage costs and pricing enhancing overall satisfaction with services provided and received. Smaller content providers, such as a local Bluegrass channel, are able to distribute content as effectively as nationwide communications networks with equal accessibility and pricing options available for each.

The previous detailed description is of a small number of embodiments for implementing the invention and is not intended to be limiting in scope. The following claims set forth a number of the embodiments of the invention disclosed with greater particularity.

What is claimed:

1. A method for distribution of media content, said method comprising:
establishing a distribution agreement with a plurality of content providers, wherein the distribution agreement authorizes the plurality of content providers to communicate the media content to a content portal with a commission paid to the content portal;
granting an authorization to distribute the media content to the plurality of content providers in response to establishing the distribution agreement;
communicating a menu of the media content available to one or more users, wherein the menu lists all of the media content available and a current price updated in real-time based on information from the plurality of content providers;
receiving a request for the media content from the one or more users;
distributing the media content requested to the one or more users;
updating an invoice for each of the one or more users based on the current price of the media content at the time the request was made; and
receiving revenue associated with the invoice for a payment to the plurality of content providers, minus the commission.

2. The method according to claim 1, wherein the distribution agreement is established through a web portal with any party that applies to be a content provider.

3. The method according to claim 1, wherein the commission is a flat fee commission charged equally to the plurality of content providers.

4. The method according to claim 1, wherein the current price is set at the sole discretion of the plurality of content providers.

5. The method according to claim 1, wherein distributing further comprises:
sending a digital rights management (DRM) key to a user configured to establish how the media content is used by a user.

6. The method according to claim 1, wherein the DRM key establishes parameters under which the media content may be viewed.

7. The method according to claim 1, further comprising:
searching the media content based on criteria specified by the one or more users.

8. The method according to claim 7, further comprising:
configuring the menu based on the criteria.

9. The method according to claim 1, wherein distributing further comprises:
distributing the media content based on a user profile and preferences.

10. The method according to claim 1, further comprising:
distributing the revenue, minus the commission, to the plurality of content providers; and
retaining the commission as payment for distributing the media content.

11. A portal for distributing media content, said portal comprising:
a content aggregator for receiving media content and information about delivery of the media content from a plurality of content providers, wherein the plurality of content providers establishes a distribution agreement with an operator of the portal before the media content may be received;
a pricing database in communication with the content aggregator configured to display a current price for the media content, wherein the current price is updated in real-time at the discretion of the plurality of content providers;
a billing system configured to initiate billing of a plurality of users for media content ordered based on the current price and further configured to initiate payment of the plurality of content providers for revenue generated from the current price, minus a commission; and
a menu system configured to display a menu listing available media content available from the plurality of content providers providing details about the media content including the current price.

12. The portal according to claim 11, wherein the portal is one or more servers, and wherein the content aggregator, pricing database, billing system, and menu system are software modules stored within the one or more servers executed to manage distribution of the media content.

13. The portal according to claim 11, wherein the billing system bills only the plurality of users for the media content requested based on a time period for billing.

14. The system according to claim 11, wherein the menu system further comprises:
a searching tool configured to receive user input for searching available media content, wherein the searching tool sends the menu for display to a user based on the user input.

15. The portal according to claim 11, wherein a user may subscribe to a channel, series of events, or other programming of the media content.

16. The portal according to claim 11, wherein the portal receives user input for selecting the media content and establishing profiles and preferences through a set-top box.

17. A content portal comprising:
a processor for executing a set of instructions; and
a memory for storing the set of instructions, wherein the set of instructions are configured to establish a distribution agreement with a plurality of content providers, wherein the distribution agreement authorizes the plurality of content providers to communicate the media content to a content portal with a commission of revenue paid to the content portal; grant an authorization to distribute the media content to the plurality of content providers in response to establishing the distribution agreement; communicate a menu of the media content available to one or more users, wherein the menu lists the media content available and a current price that is updated in real-time at the sole discretion of the plurality of content providers; receive a request for the media content from the one or more users; distribute the media content requested to the one or more users; and update an invoice for each of the one or more users based on the current price of the media content at the time the request was made.

18. The content portal according to claim 17, wherein the content portal is communication with one or more set-top boxes configured to receive requests for media content from a plurality of devices in communication with the set-top box and distributing the media content for each of the plurality of devices based on the requests.

19. The content portal according to claim 17, wherein the content portal sends the media content to a set-top box through a network connection using Internet Protocol television standards, wherein the set-top box includes a digital video recorder for storing the media content.

20. The content portal according to claim 17, wherein the set of instructions further retains the commission for distributing the media content to the one or more users.
